(19) United States
(12) Patent Application Publication
(10) Pub. No.: US 2009/0057524 A1
(43) Pub. Date: Mar. 5, 2009

(54) FIXING ASSEMBLY

(75) Inventor: Wen-Hua CHEN, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 11/849,621

(22) Filed: Sep. 4, 2007

(51) Int. Cl. F16M 7/00; F16M 13/02

(52) U.S. Cl. 248/638; 248/680

(57) ABSTRACT

A fixing assembly is used for fixing a fan having a plurality of fixing holes formed on two ends thereof. The fixing assembly includes a fixed frame, a side plate, a rotatable frame, and a plurality of first vibration absorbing members. The fixed frame is formed by bending a flexible wire for carrying the fan. The side plate is fixed on a board, and the rotatable frame is formed by bending another flexible wire, and is pivoted to the side plate to be opened or clasped on the fixed frame selectively. Each first vibration absorbing member includes a fixed portion fixed in the fixing holes of the fan and an absorbing portion for pressing against the fixed frame or the rotatable frame, so as to fix the fan on the fixed frame or the rotatable frame and absorb or isolate the vibration generated by the fan.

### BACKGROUND OF THE INVENTION

1. Field of Invention

The present invention relates to a fixing assembly, and more particularly to a fixing assembly applied in a computer device, so as to achieve a vibration absorbing effect.

2. Related Art

In a conventional computer host, a heat sink fan is directly mounted on a mainboard, so as to produce airflow to discharge hot gas in a case, and feed cool air into the case to absorb and dissipate heat. However, in the prior art, most of heat sink fans are fixed and locked on mainboards by screws. As a result, when the heat sink fan runs and vibrates, the vibration will influence the whole computer device through the contact between the fan and the mainboard, and the high-frequent vibration will influence the operation of a hard disk drive mounted on the mainboard. More specifically, a read-write head of the hard disk drive may impact tracks and be damaged when the hard disk drive is rotating in a high speed to be accessed. Therefore, in order not to influence the operation of the computer device, and especially, in order not to damage the hard disk, a vibration absorbing measure must be adopted between the fan and the mainboard.

Taiwan Patent No. M283493 discloses a vibration absorbing structure of a heat sink fan. At least one heat sink fan is mounted in an electronic equipment, so as to dissipate heat generated by each component in the electronic equipment, and the heat sink fan has bonding holes in four corners, in which vibration absorbing elements made of a vibration absorbing material are mounted. Then, securing elements, such as bolts and rivets, penetrate the bonding holes and through holes in a fixing mount, and then are fixed on the fixing mount of the electronic equipment, so that the securing elements and the bonding holes surround the vibration absorbing elements, thereby achieving the vibration absorbing effect. In the prior art, although some vibration absorbing effect is achieved, but the remnant vibration is still transmitted because the heat sink fan still contacts the fixing mount directly, and the fixing mount also contacts the mainboard directly, so the vibration absorbing effect is still undesirable. Furthermore, the fixing mount for fixing the fan, and the securing elements for locking the fan adopted in the prior art all do not have flexibility or produce the vibration absorbing effect. Therefore, resonance may be easily caused when the fan is working and vibrating, thereby influencing the operation of a hard disk and damaging the hard disk.

### SUMMARY OF THE INVENTION

In view of the above-mentioned problems, the object of the present invention is to provide a fixing assembly, in which frames for carrying a fan is made of flexible wires, so that the fan and the frame, and the frame and a case of a computer do not contact directly, but connected and spaced by vibration absorbing members for absorbing vibration. Thus the problem in the prior art that the vibration absorbing effect is undesirable is solved.

In order to achieve the aforementioned object, the present invention discloses a fixing assembly for fixing a fan on a board of a computer case. The fixing assembly includes a fixed frame, a side plate, a rotatable frame, and a plurality of first vibration absorbing members. The fixed frame is used for carrying the fan, wherein the fixed frame is formed by bending a flexible wire and is connected to the board. The side plate is fixed on the board. The rotatable frame is formed by bending another flexible wire, and is pivoted to the side plate, so that the rotatable frame is able to be opened or clasped on the fixed frame selectively. Each of the first vibration absorbing members includes a fixed portion and an absorbing portion. The fixed portions are fixed in fixing holes formed on the fan, and the absorbing portions press against the flexible wire of the fixed frame or the rotatable frame, thereby fixing the fan between the fixed frame and the rotatable frame, and absorbing and isolating the vibration generated by the fan through the first vibration absorbing members, the rotatable frame, and the fixed frame.

The fixed frame and the rotatable frame of the fixing assembly are made of a flexible wire, therefore, when contacting and fixing the operating fan, the fixed frame and the rotatable frame absorb and isolate the vibration generated by the fan by their own flexible deformation.

In addition, the first vibration absorbing members are connected to the fan, and contact the fixed frame and the rotatable frame, to prevent the fan from contacting the fixed frame, or the rotatable frame directly, thereby reducing vibration transmitted to the board and avoiding resonance of the board from occurring. The present invention achieves a favorable vibration effect by using multiple vibration absorbing structures which are cooperated with each other, so as to minimize the damage on a computer device or a hard disk caused by the vibration of the fan.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is an exploded view of a fixing assembly according to an embodiment of the present invention;

FIG. 2 is a perspective view of the fixing assembly according to the embodiment of the present invention; and

FIGS. 3, 4, 5, and 6 are schematic views of steps of operating the fixing assembly according to the embodiment of the present invention.

### DETAILED DESCRIPTION OF THE INVENTION

In order to make the object, structure, features, and functions of the present invention more comprehensible, preferred embodiments accompanied with figures are described in detail below.

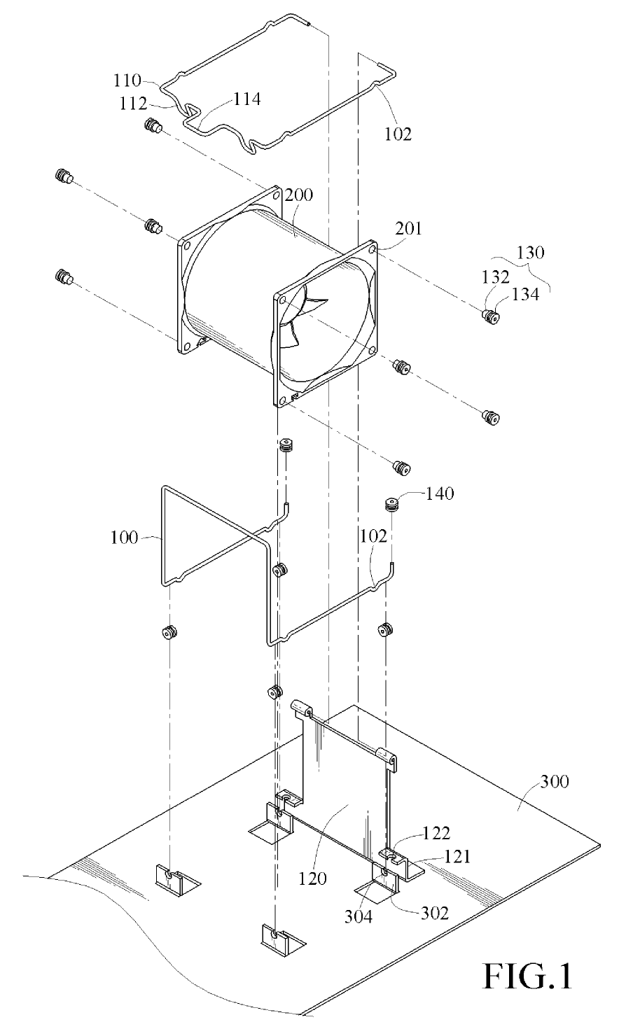

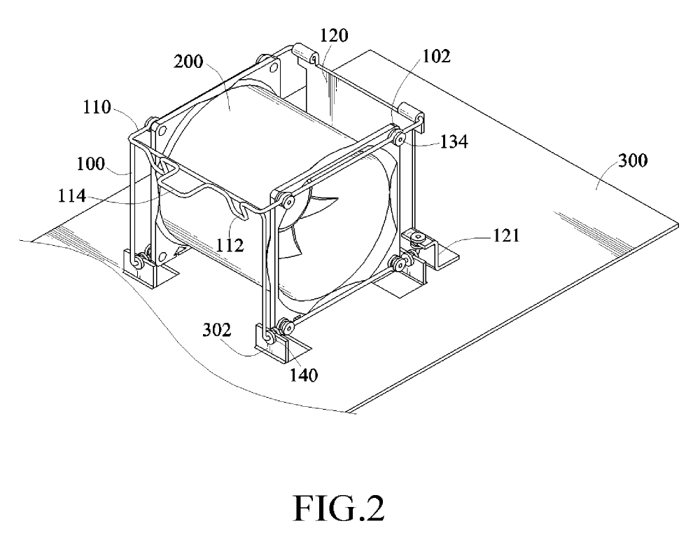

Referring to FIGS. 1 and 2, a fixing assembly of an embodiment of the present invention is shown, for fixing the fan 200 on a board 300. The board 300 may be a part of a computer case or a member disposed in the computer case.

Referring to FIGS. 1 and 2, the fixing assembly includes a fixed frame 100, a side plate 120, a rotatable frame 110, and a plurality of first vibration absorbing members 130. The fixed frame 100 is formed by bending a flexible wire and is connected to the board 300, and the fixed frame is provided for carrying the fan 200. The side plate 120 is fixed on the board 300. The rotatable frame 110 is formed by bending another flexible wire. Furthermore, the rotatable frame 110 is pivoted to the top of the side plate 120 to be opened or clasped on the fixed frame 100 selectively. Each of the first vibration absorbing members 130 includes a fixed portion 132 and an absorbing portion 134. The fixed portion 132 is fixed on one of the two ends of the fan 200, and the absorbing portion 134 presses against the flexible wire forming the fixed frame 100 or the rotatable frame 110. A slot is formed in the outer periphery of each of the absorbing portions 134, such that the flexible wire can be embedded therein to achieve the effect of fixation, and in this way, the first vibration absorbing members 130 will not move along a direction perpendicular to the flexible wire. When the rotatable frame 110 is clasped on the fixed frame 100, the first vibration absorbing members 130 may fix the fan 200 between the fixed frame 100 and the rotatable frame 110. The first vibration absorbing members 130 and the flexible wires all may absorb the vibration generated by the rotating fan and reduce the vibration amount transmitted to the board 300. The flexible wires may be metal wires.

Referring to FIGS. 1 and 2, the rotatable frame 110 further includes a clasp portion 112 and a gripping portion 114. The clasp portion 112 is formed by bending the flexible wire that forming the rotatable frame 110, and is used to be clasped on an upper edge of the fixed frame 100, thereby clasping the rotatable frame 110 on the fixed frame 100. The gripping portion 114 is formed by bending the flexible wire that forming the rotatable frame 110, and is used for a user to grip, so that the user may exert an external force on the rotatable frame 110 easily to open or clasp the rotatable frame 110 on the fixed frame 100. When the rotatable frame 110 is clasped on the fixed frame 100, a receiving region is formed between the fixed frame 100 and the rotatable frame 110 to receive the fan 200. Each of the first vibration absorbing members 130 disposed on the two ends of the fan 200 are respectively press against the fixed frame 100 or the rotatable frame 110, so as to fix the fan 200.

Referring to FIGS. 1 and 2, two ends of the fan 200 has a plurality of fixing holes 201, and the fixing holes 201 are usually formed in four corners of each of the ends of the fan 200. The fixed portions 132 of the first vibration absorbing members 130 are inserted and fixed in the fixing holes 201, while the absorbing portions 134 of the first vibration absorbing members 130 are exposed out of the fixing holes 201. When the rotatable frame 110 is clasped on the fixed frame 100, the absorbing portions 134 of the first vibration absorbing members 130 may contact and press against the flexible wire of the fixed frame 100 or the rotatable frame 110, thereby fixing the fan 200 between the fixed frame 100 and the rotatable frame 110.

Referring to FIGS. 1 and 2, in order to prevent the vibration generated by the working fan 200 in the fixed frame 100 from affecting the operation of a computer device or an electronic device having the fan 200, the vibration transmitted from the fixed frame 100 to the board 300 must be reduced. Therefore, the present invention further includes second vibration absorbing members 140 to further isolate the fixed frame 100 from the board 300. The fixing assembly of the present invention further includes a plurality of supporters 302 fixed on the board 300, and the second vibration absorbing members 140 are respectively disposed on the supporters 302 of the board 300. Each of the supporters 302 has a notch 304. Each of the second vibration absorbing members 140 is respectively embedded and fixed in the notches 304 of each of the supporters 302, so as to be fixed in the supporters 302 of the board 300. The second vibration absorbing members 140 are penetrated by the flexible wire of the fixed frame 100 to be fixed on the fixed frame 100. Furthermore, the second vibration absorbing members 140 are fixed at positions corresponding to the notches 304 of the supporters 302, such that the second vibration absorbing members 140 are embedded in the notches 304. When the second vibration absorbing members 140 are disposed on the fixed frame 100, the fixed frame 100 is connected to the supporters 302 of the board 300, so as to be fixed on the board 300. When the fan 200 is working, the vibration may be additionally reduced due to the second vibration absorbing members 140. In this embodiment, the second vibration absorbing members 140, and the absorbing portions 134 of the first vibration absorbing members 130 are all made of a flexible material, such as rubber, foam, or polymer, such as styrofoam.

As shown in FIG. 2, the side plate 120 further includes two connecting members 121 respectively corresponding to both sides of the side plate 120. Each of the connecting members 121 also has a notch 122. Therefore, second vibration absorbing members 140 corresponding to the two connecting members 121 are also disposed on the portions of the fixed frame 122 corresponding to the side plate 120. The two second vibration absorbing members 140 may be embedded in the notches 122 of the two connecting member 121, so as to be disposed on the connecting members 131 of the side plate 120. Since the second vibration absorbing members 140 are penetrated by the flexible wire of the fixed frame 100 and are disposed on the fixed frame 100, the fixed frame 100 may be fixed on the side plate 120 through the two second vibration absorbing members 140.

Referring to FIGS. 1 and 2, the absorbing portions 134 of the first vibration absorbing members 130 contact and press against the flexible wire forming the fixed frame 100 or the rotatable frame 110, in order to avoid the absorbing portions 134 slides along a direction parallel to the flexible wire, the absorbing portions 134 of the first vibration absorbing members 130 must be limited, so as to position and fix the fan 200. A plurality of limiting structures 102 is respectively formed on positions of the rotatable frame 110 and the fixed frame 122 contacting the absorbing portion 134. The limiting structures 102 are bent section formed by bending the flexible wire, and match the absorbing portions 134 of the first vibration absorbing members 130, so that the absorbing portions 134 are embedded in the limiting structures 102. Accordingly, the first vibration absorbing members 130 are fixed in a direction parallel to the flexible wire, so that the absorbing portions 134 are limited when pressing against the fixed frame 100 or the rotatable frame 110.

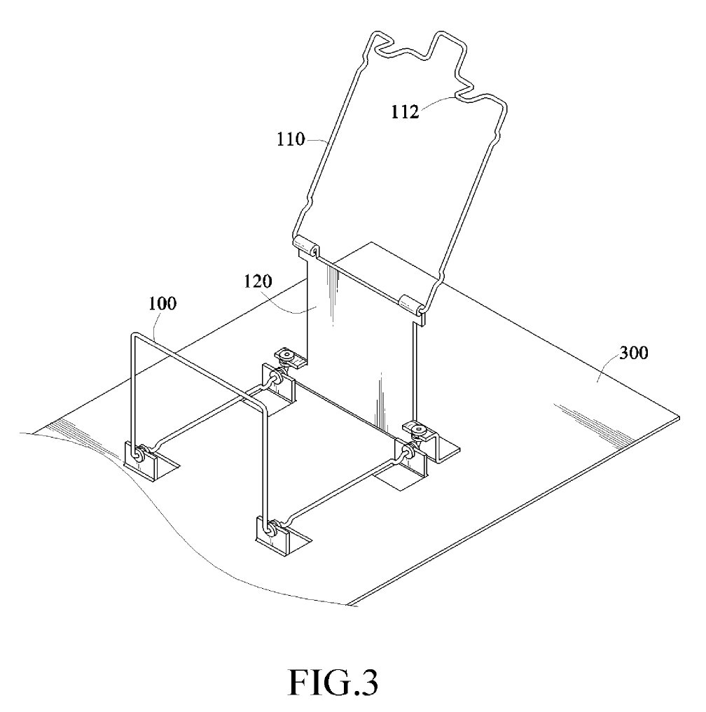

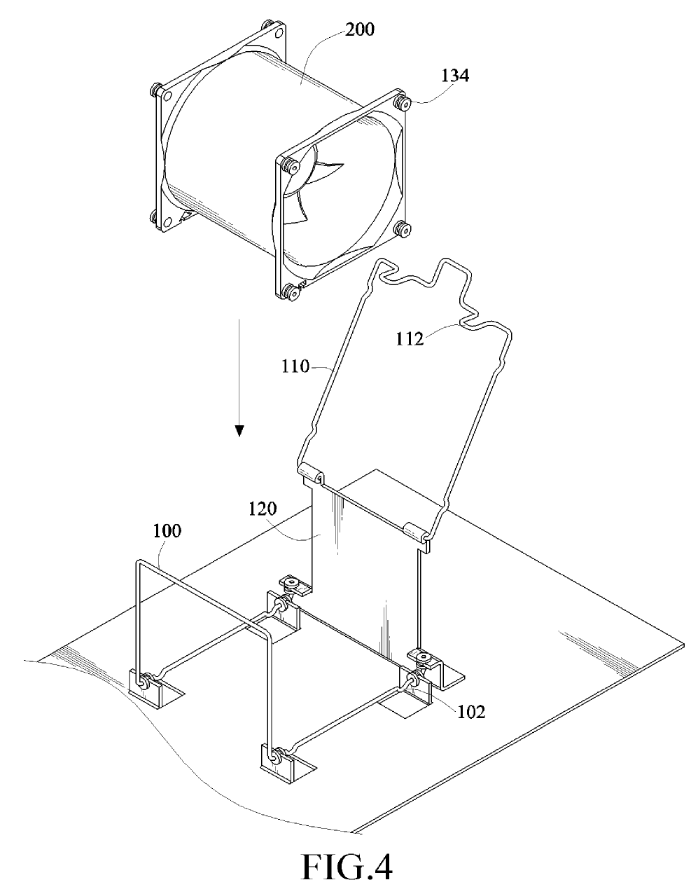

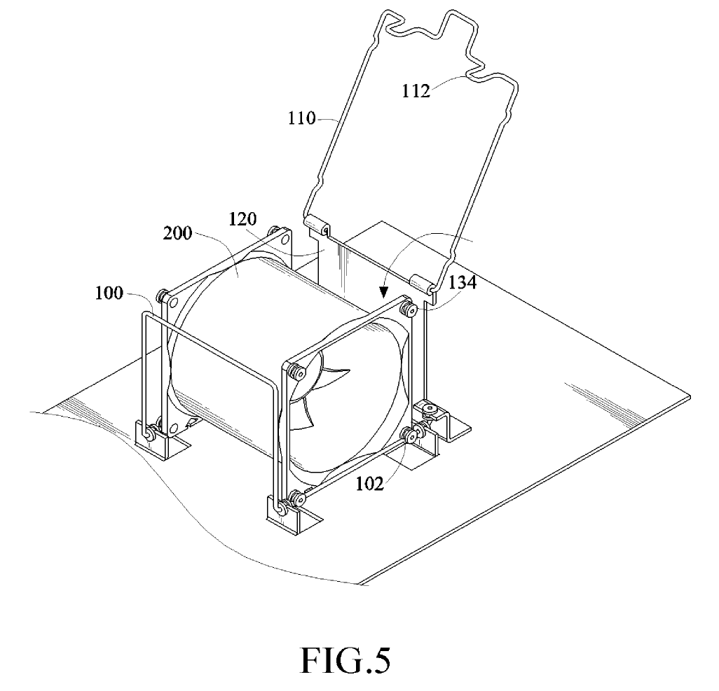

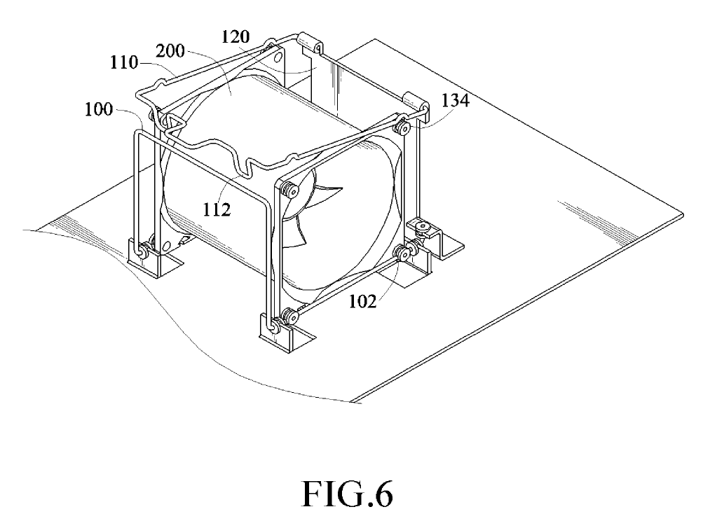

Please referring to FIGS. 3-6, schematic views of the steps of operating the fixing assembly of the present invention are shown. When the fan 200 is to be mounted on the board 300, firstly, the rotatable frame 110 is kept opened, the fan 200 fixed with a plurality of first vibration absorbing members 130 is placed in the fixed frame 100, and the absorbing portions 134 of the first vibration absorbing members 130 under the fan 200 correspond to the limiting structures 102 of the fixed frame 110. An external force is exerted to clasp the rotatable frame 110 on the fixed frame 110, and the clasp portion 112 of the rotatable frame 110 is used to make the rotatable frame 110 be clasped on the upper edge of the fixed frame 100. At this time, each of the limiting structures 102 of the rotatable frame 110 tightly contact the absorbing portions 134 of the first vibration absorbing members 130 above the fan 200. The aforementioned steps have achieved the effect of fixing the fan 200 by using the fan fixing assembly disclosed in the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A fixing assembly for fixing a fan on a board, comprising:
a fixed frame, formed by a flexible wire for carrying the fan, and connected to the board;
a side plate, fixed on the board;
a rotatable frame, formed by another flexible wire, and pivoted to the side plate to be opened or clasped on the fixed frame selectively; and
a plurality of first vibration absorbing members, wherein each of the first vibration absorbing members has a fixed portion fixed on the fan and an absorbing portion pressing the fixed frame or the rotatable frame.

2. The fixing assembly as claimed in claim 1, further comprising a plurality of second vibration absorbing members disposed on the board, wherein the second vibration absorbing members are penetrated by flexible wire of the fixed frame to be fixed on the fixed frame, for fixing the fixed frame on the board.

3. The fixing assembly as claimed in claim 2, further comprising a plurality of supporters fixed on the board, wherein each of the second vibration absorbing members is disposed on each of the supporters respectively.

4. The fixing assembly as claimed in claim 3, wherein each of the supporters further has a notch formed thereon, and each of the second vibration absorbing members is embedded in the notch of each of the supporters respectively.

5. The fixing assembly as claimed in claim 1, further comprising at least one second vibration absorbing member disposed on the side plate, wherein the second vibration absorbing member is penetrated by the flexible wire of the fixed frame to be on the fixed frame, to fix the fixed frame on the side plate.

6. The fixing assembly as claimed in claim 5, wherein the side plate further includes at least one connecting member having a notch and the second vibration absorbing member is embedded in the notch of the connecting member.

7. The fixing assembly as claimed in claim 1, wherein the rotatable frame and the fixed frame have a plurality of limiting structures respectively, and the limiting structures are bent sections formed by bending the flexible wires of the rotatable frame and the fixed frame for matching the absorbing portion of each of the first vibration absorbing members.

8. The fixing assembly as claimed in claim 1, wherein the rotatable frame further includes at least one clasp portion formed by bending the flexible wire of the rotatable frame, to be clasped on the fixed frame.

9. The fixing assembly as claimed in claim 1, wherein the rotatable frame includes a gripping portion formed by bending the flexible wire of the rotatable frame.
